(19) United States
(12) Patent Application Publication
(10) Pub. No.: US 2008/0010555 A1
(43) Pub. Date: Jan. 10, 2008

(54) Method and Apparatus for Measuring the Cost of a Pipeline Event and for Displaying Images Which Permit the Visualization orf Said Cost

(76) Inventors: Phillip Emma, Danbury, CT (US); Alian Hartstein, Chappaqua, NY (US); Daniel N. Lynch, Austin, TX (US); Thomas R. Puzak, Rigefield, CT (US); Vijayalakshmi Srinivasan, New York, NY (US)

Correspondence Address: DANIEL E. MCCONNELL;THE MCCONNELL LAW FIRM, 2115 ST. MARY'S STREET, RALEIGH, NC, 27606, US

(21) Appl. No.: 11/424,696

(22) Filed: Jun. 16, 2006

(51) Int. Cl. G06F 11/00

(52) U.S. Cl. 714/47

(57) ABSTRACT

A hardware monitor is used to monitor the sequence of instructions executed during a miss cluster. The monitor groups each cache miss into a miss cluster, and the miss penalty associated with each cluster is determined by identifying a set of instructions that were executed during the miss cluster. The finite cache running time is then calculated for the set of instructions that occurred during the miss cluster. Additionally, an infinite cache running time is determined for the same set of instructions that occurred during the miss cluster, where the infinite cache running time is the time needed to execute this set of instructions in the absence of any miss. The cost of the miss cluster is then calculated by measuring the difference between the finite cache running time and the infinite cache running time.

### FIELD AND BACKGROUND OF INVENTION

The rapid pace of technology improvements (both in speed and circuit density) has seen the internal organization of a processor become more complex. In today's processors the pipelines are faster, deeper, and wider that ever before. However, the relative speed of the memory has not kept pace with the frequency (cycle time) of the processor and proportionally a greater percent of a program's performance is lost due to pipeline events including cache misses. To reduce the amount of time lost to cache misses, designers have added many levels of caches. It is common for a processor to have two, three, or even four levels of cache between the processor and memory.

Software complexity has also grown matching that of the processor. Operating systems and applications are more complex. Operating systems are multi-programed and must communicate with several processors all running a common application. Applications are multithreaded and share a common data base. Performance analysis through simulation is becoming increasingly more difficult due to artificial delays imposed by the software simulation tools.

In order to analyze a processor's or application's performance, designers have turned to hardware monitors to provide a real time breakdown of a program's execution time. Hardware monitors are unobtrusive and do not slow down the execution of the application and do not impose delays or overhead cycles in the processor. Hardware monitor are able to run in parallel with the processor and provide detailed information regarding bottlenecks found in the processor or application. A performance monitor can provide a breakdown of the instructions executed by an application (op-code mix), and a characterization of the pipeline delays encountered by the application.

A number of prior patents are directed to hardware monitors, each having certain advantages and disadvantages. For example, U.S. Pat. No. 5,862,371, No. 5,894,575 and No. 5,878,208 to Levine et al, commonly assigned to the assignee of the present invention and herein incorporated by reference in their entirety, describe a method for instruction trace collection and reconstruction using a hardware monitor. The hardware monitor collects initial processor state information (cache and memory contents), bus activity, instruction execution information, and interrupt information so that trace tape reconstruction software may be utilized to accurately and efficiently determine the actual instruction sequence which occurred. Once a trace is collected performance analysis can be accomplished off-line, not in real time. This method of trace tape collection and reconstruction is used when it is desired to trace entire workloads (100s of millions to billions of instructions) and collecting this information in real time is impractical. In the present invention, trace tape collection is also employ but the traces are much smaller, (10s to 100s of instructions) and the trace can be collected in real time and saved by a hardware monitor.

U.S. Pat. No. 6,353,805 B1 and No. 6,052,802 to Zahir et al, describe a performance monitor that assigns delays according to a set of prioritized rules. Delay signals are first captured in a series of storage elements (silos). Each silo records delay signals from the pipeline. This delay information is then sent to a prioritizer which calculates delays based on a set of rules.

U.S. Pat. No. 5,845,310 and No. 6,081,868 to Brooks calculate memory delays by counting cache misses and idle cycles suffered by the processor. Applications are instrumented by profiling to determine sections of the code that cause the most misses. Compilers then add monitor calls to critical sections of the application to turn on or off the hardware monitor to gather performance information.

U.S. Pat. No. 6,256,775 to Flynn describes a method for measuring the performance characteristics of a multithreaded processor. The processor uses additional treads for recording selectable events during the execution of the first thread.

U.S. Pat. No. 6,892,173 to Gaither et al, describes a mechanism for estimating the hit ratio of the cache. The method consists of monitoring the addresses on a bus and saving this information in memory. The address are then applied to a software model of a cache where estimates of the hit rate and other parameters of interest are computed.

U.S. Pat. No. 5,594,864 to Trauben describes a mechanism for monitoring processor states and characterizing bottlenecks in an application. Performance signals are routed from the integer and floating point functions to a monitor where the number of instructions issued, and the execution-unit busy cycles can be determined. Through analysis of the output, bottlenecks in the application as well as information permitting optimization of the application can be determined.

One major cause of performance lose is the number of cache misses an application takes and the cost of each cache miss. Many applications spend over half their time waiting on cache misses. Simply counting the number of misses or cycles waiting on an operand does not accurately measure the time spent waiting on a miss. The amount of time lost to each miss can vary greatly. One underlying reason is that misses cluster and the clustering of misses can quickly push bus utilization to undesired levels. These queuing effects can greatly effect the amount of time that each miss costs.

There are many reasons for delays to be introduced into a processor when running an application. The application can generate cache misses, execution interlocks, memory and address interlocks, branch mis-predictions, and memory access delays. Each of these can introduce delay cycles into a particular component of a processor. However, not all delays actually contribute to the overall delay of a program. Today's processors have superscalar capabilities and parallel execution paths and a delay suffered in one component of a processor can be overlapped with other delays encountered in the processor. For example, consider two events occurring in parallel: a branch miss-prediction and a cache miss. Simply counting the number of cycles an instruction is stalled waiting on a miss is not an accurate measure of the cost of the miss since many of the cycles can be overlapped with the delays caused by the branch miss-prediction. Additionally, multithreaded computers switch execution threads when a cache miss occurs trying to overlap a cache miss with useful work. Consequently, accurate performance analysis is not easy. Simply counting events (like cache misses, branch miss predictions, or cycles waiting on a memory request) does not accurately report where an application is losing performance. It is vital for the performance monitor to provide an accurate and detailed understanding of which types of delay are causing a performance loss. This information can allow designers to modify the hardware or software to improve performance, thus causing the application to run faster.

### SUMMARY OF THE INVENTION

With the foregoing in mind, it is one purpose of the present invention to provide an improved method and system for measuring the cost of a cache miss and a method for displaying images that represent said cost. It is another purpose of the present invention to provide an improved method and system for measuring the cost of a cache miss and displaying images representing said cost utilizing a hardware monitor.

According to the present invention, the operations of a processor are traced in real time and an accurate and detailed description of the cycles lost due to a miss are produced in real time. The present invention incorporates a hardware monitor that can detect whenever a cache miss is in progress, count the number of misses that occur during a miss cluster, and record the instruction sequence issued by the processor during a miss cluster. The monitor will then determine the time needed (cycles) to execute the same set of instructions in the absence of all cache misses. The difference between these two times is the cost of the miss. Moreover, the present invention acts in parallel with the processor it is monitoring and does not slow down the processor or application. This information can then be presented to hardware and software designers to provide insights into the performance characteristics of the application, operating system, or processor hardware.

The cost of a miss is calculated by first determining the amount of time (cycles) needed to run a sequence of instruction in the presence of a cache miss or a cluster of misses. Let this time be denoted as T1. Also, according to the present invention, the amount of time needed to process the same sequence of instructions in the absence of misses is determined, let this time be denoted as T2. Then, the amount of time the processor is stalled due to the miss (cost of the miss) is the difference between T1−T2.

The forgoing purposes are achieved as will be described hereinafter. A method and system are disclosed for collecting instruction trace information utilizing a hardware monitor. Whenever a miss or cluster of misses occur, the hardware monitor records the instructions executed by the processor during the period of time that misses occur. Additionally the hardware monitor is used to determine the miss cluster size and amount of time the processor took to execute the set of instructions that occurred during the miss cluster. The hardware monitor is used to produce a cache miss spectrogram which represents a precise readout showing a detailed histogram (visualization) of the cost of each cache miss. A miss spectrogram is helpful to anticipate, understand, and diagnose performance problems common to many applications running in a multilevel memory hierarchy. Cache miss spectrograms are produced by comparing the execution times for the sequence of instructions that occurred during the miss, (a ‘finite cache time’) to the amount of time needed to execute the same sequence of instructions without any cache misses, an ‘infinite cache time’. Cache misses are divided into clusters, and the miss penalty associated with each cluster is determined by identifying an upper and lower bound set of instructions around each miss cluster and calculating the cycle difference in time between these instructions. Detailed analysis of a spectrogram leads to much greater insight in pipeline dynamics, including effects due to prefetching, pipeline restarts, branch prediction errors, and bus queueing delays.

It is to be understood that the technology here described has broader application. A cache miss is one of a category of events which may be characterized as pipeline events. Other pipeline events with which the technology here described is useful for analysis are branch prediction errors and execution interlocks. While the description which follows is focused on cache miss analysis, attention will be given to identifying the boundaries of program instructions which create the additional types of pipeline events here mentioned.

### BRIEF DESCRIPTION OF DRAWINGS

Some of the purposes of the invention having been stated, others will appear as the description proceeds, when taken in connection with the accompanying drawings, in which:

FIG. 1 illustrates two miss clusters and the execution timings of five instruction in the presents of cache misses and in the absence of misses;

FIG. 2 illustrates the visualization of the cost of a miss according to the present invention, a “Miss Spectrogram”;

FIG. 3 illustrates the format and contents of the Trace Scoreboard (TSB) according to the present invention;

FIG. 4 is a functional block diagram of a processor with a hardware monitor according to present invention;

FIG. 5 is a flowchart diagram explaining the action of the hardware monitor receiving signals and data from the processor's miss facility according the present invention;

FIG. 6 is a flowchart diagram explaining the actions of the hardware monitor receiving signals and data from the processor's decoder according to the present invention; and

FIG. 7 is a flowchart diagram explaining the actions of the hardware monitor receiving signals and data from the processor's execution unit and EndOp unit according to the present invention

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The overall methodology used to calculate the cost of a miss and visualization process are explained as a prelude to describing the operation of the present invention. First, the definitions and formulas used to calculate the cost of a miss are described, then a description is set forth relative to how misses cluster and effect the standard operation of a high performance processor, followed by a description of the visualization process.

The most commonly used metric for processor performance is, “Cycles Per Instruction” (CPI). The overall CPI for a processor has two components: an “infinite cache” component (CPI_{INF}) and a “finite cache adder” (CPI_{FCA}).

CPI_{OVERALL}=CPI_{INF}+CPI_{FCA} (1)

CPI_{INF} represents the performance of the processor in the absence of misses (cache, and TLB). It is the limiting case in which the processor has a cache that is infinitely large and is a measure of the performance of the processor's organization with the memory hierarchy removed. CPI_{FCA} accounts for the delay due to cache misses and is used to measure the effectiveness and performance of the memory hierarchy.

Just as processor performance (for both in-order and out-of-order machines) can be expressed in terms of a CPI, the “memory adder” can be expressed as the product of an event rate (specifically, the miss rate), and the average delay per event (cycles lost per miss):

$${CPI}_{FCA} = ( \frac{Misses}{Instruction} ) ( \frac{Cycles}{Miss} ) \qquad ( 2 )$$

Substituting for CPI_{FCA} in (1), the overall performance for a processor can be expressed as:

$${CPI}_{OVERALL} = {CPI}_{INF} + ( \frac{Misses}{Instruction} ) ( \frac{Cycles}{Miss} ) \qquad ( 3 )$$

By rearranging this formula, the average cost of a cache miss can be calculated. That is

$$( {CPI}_{OVERALL} - {CPI}_{INF} ) ( \frac{Instruction}{Miss} ) = ( \frac{Cycles}{Miss} ) \qquad ( 4 )$$

It is a purpose of this invention to use this formula to calculate the amount of time (cycles) a processor loses due to each cache miss. As mentioned briefly above, the technology described here with reference to cache miss analysis is useful also for other pipeline events and the person of skill in the art will understand such applications of the invention. The following example illustrates calculating cycles per miss using equation (4). Consider an application whose entire run length is one million instructions and a processor with a memory hierarchy where each cache miss is satisfied from the L2 that is 20 cycles away. If an infinite cache simulation run takes one million cycles (CPI_{INF}=1) and a finite cache simulation run takes 1.3 million cycles, then cache miss stalls accounted for 300,000 cycles and the total CPI_{Overall}=1.3 and CPI_{FCA}=0.3. If the finite cache simulation run generated 25,000 misses then (Misses/Instruction)=(25,000/1,000,000)=1/40 and (Cycles/Miss)=(300,000/25,000)=12. By applying this equation over the entire length of an application the average cost for all misses can be calculated.

Additionally, this equation can also calculate the cost of a single miss. For example, consider an application consisting of 100 instructions. Let a miss start after instruction 11 is decoded (at cycle=31) and end just before instruction 20 is executed (at time 60). Note, this represents a sequence of 10 instructions over 30 cycles consisting of single miss. Then, the overall CPI for these 10 instructions is CPI_{OVERALL}=30/10=3. Let the infinite cache execution time for these same 10 instructions be 14 cycles, then CPI_{INF}=1.4 and from (4) the cost of the miss is (3.0−1.4)(10/1)=16 cycles.

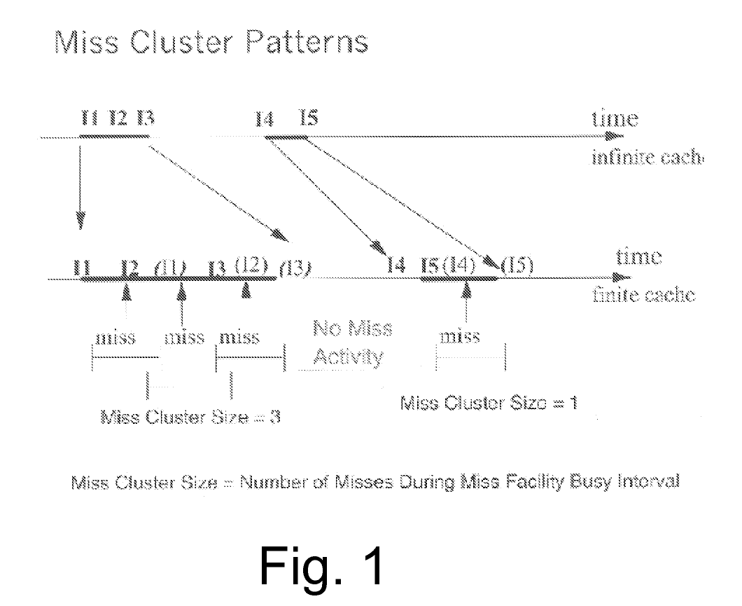

A description of how misses can cluster and effect the performance of a processor is now described. FIG. 1 shows the same set of five instructions executed as an ‘infinite cache’ sequence of instructions and a ‘finite cache’ sequence of instructions. In the finite cache sequence, the instruction decode times are shown in bold and instruction EndOp or completion times are shown in parenthesis. In the infinite cache run only the instruction decode times (in bold) are shown. Associated with the finite cache run are two miss clusters, where a miss cluster represents the time a processor starts processing a miss (or multiple misses) until the miss processing is complete (the miss facility becomes idle). In the finite cache run, the first miss cluster has three misses with overlap (size=3) and the second miss cluster is size=1 (a miss in isolation). The time to process the first miss cluster (in the finite cache run) is bounded by the decode time for instruction I1 and the EndOp time of I3, (I3EndOp−I1Decode)_{Finite Cache} time. Instruction I1 represents the greatest lower bound (Infimum) of the miss cluster, while instruction I3 is the least upper bound (supremum) of the cluster. (By convention, the infimum of a miss cluster is the greatest instruction that decoded prior to the beginning of the first miss in the miss cluster and the supremum of the miss cluster is the least instruction that completed after the last miss in the miss cluster ended.) Similarly, the infimum instruction of the second miss cluster is I4 and the supremum is I5. The time to process the second miss cluster is then (I5EndOp−I4Decode)_{Finite Cache}. To calculate the amount of delay associated with the first miss cluster we must subtract the amount of time to process the same set of instructions in an infinite cache run from the finite cache run. That is, [(I3EndOp−I1Decode)_{Finite Cache}−(I3EndOp−I1Decode)_{Infinite Cache}] equals the number of cycles that the pipeline was stalled due the first miss cluster. Similarly, the amount of delay associated with the second miss cluster is [(I5EndOp−I4Decode)_{Finite Cache}−(I5EndOp−I4Decode)_{Infinite Cache}]. As will be understood, this determination of boundaries is applicable as well to other pipeline events as have been here described.

By grouping misses according to their cluster size and calculating the delay associated with a miss cluster (number of stall cycles) using the method describe above, the amount of time a processor loses due to cache miss is produced.

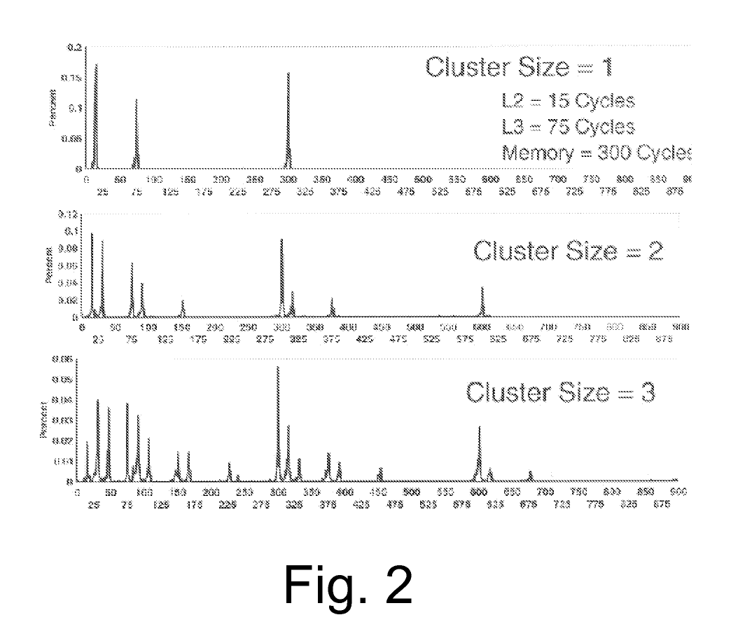

With the definitions, formulas, and miss clustering patterns explained, FIG. 2 shows a graph that permits the visualization of the cost of a miss according to the principles of the present invention. This is referred to as a ‘miss spectrogram’. For example, consider a memory hierarchy consisting of an L1, L2, L3, and memory. Let the miss latency for an L1 miss be: 15 cycles for a L2 hit, 75 cycles for a L3 hit, and 300 cycles if the miss goes all the way to memory. The miss spectrograms for cluster sizes=1, 2, and 3 are shown. The X dimension represent the cost of the miss. The Y dimension shows the percent of misses that had that delay.

The cluster=1 plot shows three peaks. The first peak is centered near 15 cycles (the L2 miss latency), the second peak is near 75 cycles (the L3 miss latency) and the third peak at 300 cycles (the memory latency). Integrating the area under each peak is approximately the percent of L1 misses that are resolved in that level of the memory hierarchy. These represent the hit ratios for the L2, L3, and memory. The cluster=2 plot shows peaks at 15, and 30 cycles (representing two L1 misses that hit in the L2 with and without overlap), peaks at 75 and 90 (representing two L3 hits with overlap or two L1 misses where one hits in the L2 and one hits in the L3), a peak at 150 (two L3 hits without overlap), a peak at 300 (two L1 misses where one was resolved in the memory and one with overlap), a peak at 315 (combinations of two L1 misses where one hits in the L2 and one went to memory), a peak at 375 (combinations of a L3 hit and L3 miss), and a peak at 600 (two L1 misses that were satisfied from memory without overlap).

Similarly, the peaks in the cluster=3 graph represent all of the Hit/Miss combinations of length 3 using the three miss latencies (15, 75, and 300) for the L2, L3 and memory. Each peak represent the amount of time that the group of cache misses (cluster) stalled the pipeline. Prefetching can broaden the left shoulder of any peak and reduce miss latency. Queueing and bus delays can increase the right shoulder of a peak adding miss latency. These plots have enormous value to hardware and software designers by identifying potential performance problems associated with the processor's hardware or software.

With the formulas, methodology and miss patterns fully described, the structure and operation of present invention is now described. It should be noted that there are many designs for this invention. The one presented here is chosen for simplicity of exposition rather than optimality of design. For example, many table lookup structures are assumed fully associative rather than the more common set-associative ones which would probably be used in an actual implementation.

It is convenient to consider the generation of a miss spectrogram as a 5 step synchronized process controlled by the hardware monitor. The steps are:

1. The hardware monitor must detect when a miss occurs and count the number of misses in a miss cluster.

2. The hardware monitor must save all of the instructions that occurred during the miss cluster along with associated decode and execution information in a trace scoreboard. The instructions saved in the trace scoreboard are those from the decode point of the first instruction that proceeded the first miss in a miss cluster (the infimum instruction), to the EndOp of the first instruction that followed the end of the miss cluster (the supremum instruction). Later, the hardware monitor will use these instructions to determine a finite cache and an infinite cache CPI.

3. The hardware monitor must determine the finite cache running time for the sequence of instructions saved in step 2. This is simply the difference in time between the supremum instruction and the infimum instruction. Recall this is CPI_{OVERALL}.

4. The hardware monitor must determine the infinite cache running time for the same sequence of instructions saved in step 2. This is CPI_{INF}. This is accomplished by reprocessing (executing) the set of instructions saved in step 2, in the absence of any cache miss. The monitor will use appropriate decode and execution information saved in step 2 to accomplish this.

5. The hardware monitor must calculate the cost of the miss cluster and save that value in a table for display.

To produce a miss spectrogram steps 1, 2 and 3 occur in parallel (while a miss cluster is in progress) while steps 4 and 5 follow after the miss cluster is over

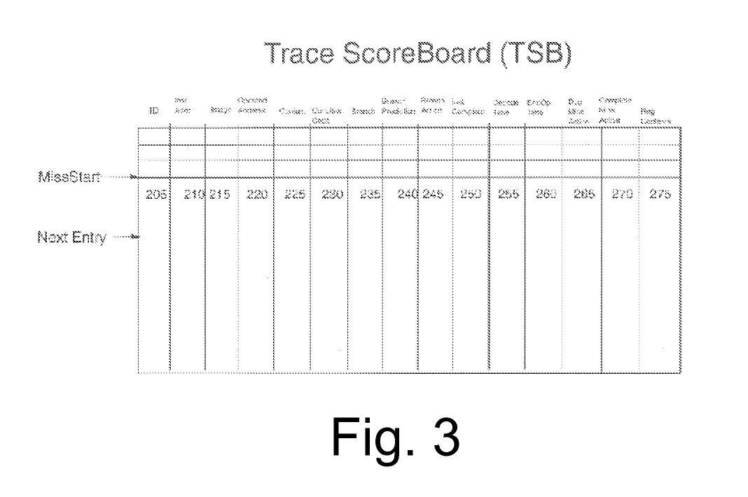

Before describing the operation of the hardware monitor to accomplish these steps it is helpful to describe the contents of the Trace Scoreboard (TSB), identified in step 2 above. In the preferred embodiment of the present invention it is necessary to collect a trace tape to determine the infinite cache CPI for the instructions that occurred during the miss cluster. The hardware monitor will save (in the trace scoreboard) the exact sequence of instructions executed by the processor while the misses in the miss cluster occurred. Analysis has shown that most miss clusters are less than 10 misses in length, and traces of less than 100 instructions typically contain all of the instructions executed by a processor during a miss cluster. FIG. 3 shows the essential features of the Trace Scoreboard. The figure shows the TSB as an array of entries consisting of the following fields:

The Instruction IID 205: Typically the decoder assigns to every instruction that it decodes a unique instruction-identifier (IID). This IID is used to control the execution sequence of each instruction as it proceeds through the processor. For example, a designated register in the decoder is used to assign the IID values. This register is incremented by one each time an instruction is decoded. The IID 205 field in the TSB is set equal to the IID of the instruction that was just decoded.

Instruction Address 210: The address of the instruction just decoded, including virtual and real tags.

Instruction Image 215: This image of the instruction (machine language format)

Operand address 220: The address of any operand fields fetched by the instruction.

Operand Contents 225: The contents of any operand fields fetched by the decoded instruction.

Condition Code 230: If the instruction sets the condition code this value is saved after the instruction completes.

Branch tag 235: one bit field denoting the instruction is a branch 1=branch, 0=not-a-branch

Branch Prediction 240: if instruction is a branch, the prediction used by the processor. 1=predicted taken, 0=predicted not-taken

Branch Action 245: The outcome of the branch, 1=taken, 0=not-taken

Instruction Complete Tag 250: One bit field denoting the instruction is complete, 0=not complete, 1=complete. Obviously when the instruction first enters the TSB this field is set to zero and then set to one after complete.

Decode Time 255: The time (cycle number) the instruction was decoded.

Complete Time 260: The time (cycle number) the instruction completed (EndOp).

Decode Miss Facility Active 265: One bit field denoting the status of the miss facility when the instruction was decoded. Set to 1 if the miss facility was busy when the instruction was decoded, 0 otherwise.

Complete Miss Facility Busy 270: One bit field denoting the status of the miss facility when the instruction was completed. Set to 1 if the miss facility was busy when the instruction was completed (EndOp), 0 otherwise.

Register Contents 275: Contents of registers used at decode or execution time.

Two pointers are used to reference the TSB. The first is the Next-Entry pointer. This pointer points to the next free row in the TSB and is used to index through the TSB one row at a time (incremented by one) saving decode information for the instruction that is just decoded. Wrap-around logic exits to reposition the Next-Entry pointer to the top of the TSB whenever that last entry of the array is used.

It is also noted that the hardware monitor has logic to detect when the sequence of instructions identified by the supremum and/or Infimum instruction have exceeded the total number of instructions that can be saved in the TSB. If this occurs, the TSB is reset to initial state values and the monitor waits for the next miss cluster to begin.

Also there are certain boundary conditions that must be considered when determining the infimum and supremum of a miss cluster. For example, the infimum of a miss cluster can only be established after the supremum of the previous miss cluster has been determined. This assures that one miss cluster is terminated before another starts. If the upper and lower bounds of a miss cluster cannot be uniquely established, the two adjoining miss clusters are combined into a large miss cluster.

Also, when determining the infinite cache running time for an instruction sequence that occurred during a miss cluster, it may be necessary to prime the processor's pipeline with some of the instructions that occurred prior to the infimum instruction. This is necessary to assure that the correct execution and EndOp times of the infimum instruction are preserved as it passes through the processor's pipeline.

By grouping misses according to their cluster size and calculating the delay associated with a miss cluster (number of stall cycles) using the method describe above, the amount of time a processor loses due to cache miss is produced.

The second pointer is the MissStart pointer. This pointer points to the instruction (TSB row) that was decoded prior to the start of a miss cluster. Typically the instruction identified by this pointer is the infimum instruction of the miss cluster.

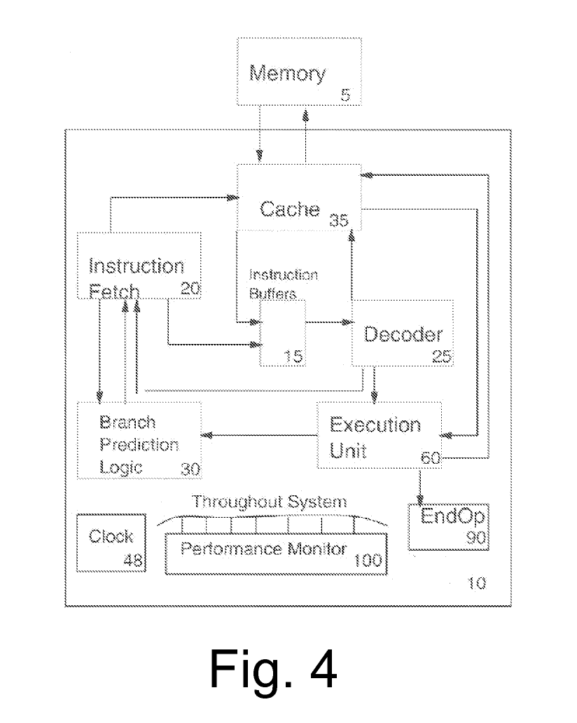

FIG. 4 shows the characteristic features of a typical high performance processor 10 with a hardware monition according to the present invention. In the illustrative embodiment, processor 10 is a integrated superscalor microprocessor. The figure shows the major elements of a processor necessary to support the present invention.

Memory 5: Stores instructions and operands for programs on the processor. The most recently used portions of memory are transferred to the cache.

Cache 35: High speed memory where instructions and data are saved. Supplies the instruction buffer with instructions and execution units with operands. Also receives updates (stores) from the execution units. (Note, a common or unified cache is presented in this design description, however the description could easily be adapted to split or separate instructions and data caches.)

Instruction Buffer 15: Holds instructions that were fetched by the instruction fetch logic

Decoder 25: Examines the instruction buffer and decodes instructions. Typically, a program counter (PC) register exists that contains the address of the instruction being decoded. After an instruction is decoded it is then sent to its appropriate execution unit.

Execution units 60: Executes instructions. Typically, a processor will have several execution units to improve performance and increase parallelism. For example, it is common for a processor to have load/store unit(s), floating point, fixed point, and branch units.

End Op (Completion) unit 90: marks the completion of the instruction where all results from the instruction are known throughout the machine and architected state is preserved.

Branch prediction Mechanism 30: Records branch action information (either taken or not-taken) for previously executed branches. Also guides the instruction fetching mechanism through taken and not-taken branch sequences and receives updates from the branch execution unit. Typically the branch prediction logic and instruction fetching logic work hand in hand with branch prediction running ahead of the instruction fetching by predicting upcoming branches.

The instruction fetching mechanism 20: will use the branch prediction information to fetch sequential instructions if a branch is not-taken or jump to a new instruction fetch address if a branch is predicted as being taken.

Performance (Hardware) Monitor 100: Monitors results from all parts of processor. The performance monitor is utilized in a manner well known to those having ordinary skill in the art, to optimize the performance of a data processing system. Timing data from the performance monitor may be utilized to optimize both hardware and software. In addition, the performance monitor may be utilized to collect data about access times from system caches and main memories and monitor performance from other parts of the processor (Decoder, E-units, branch prediction, bus utilization, miss facility, etc.). Additionally, the performance monitor has the ability to determine the run time (execution time) of a small sequence of instruction in the absence of cache misses. To accomplish this, many of the functions described in the present invention would actually be integrated into the performance monitor and that the performance monitor could be a duplicate of the processor 10 shown in FIG. 4. With the advent of multi-core chips (many processors on a chip) the performance monitor could even be a duplicate of the processor 10 already on the same chip. The features and operations of the hardware monitor will be described more fully below.

Finally, clock 48 is depicted schematically within FIG. 4. Clock 48 is utilized to provide processor clock cycles to the various units within the processor 10 system.

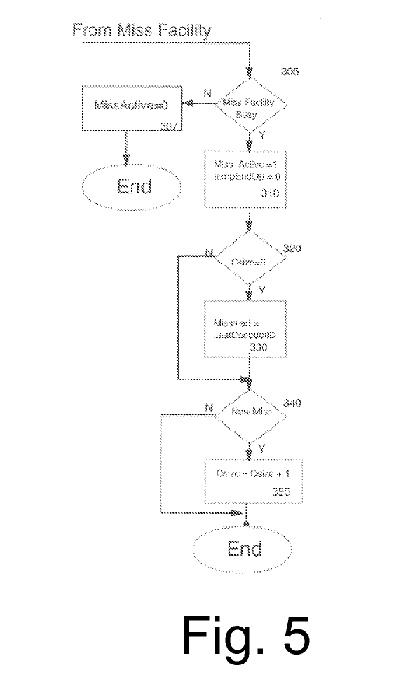

As noted, steps 1, 2 and 3 occur in parallel within the hardware monitor and represent: calculating the miss cluster size, collecting a trace of the instructions that occurred during the miss cluster and calculating the CPI_{OVERALL} time. These functions are accomplished by the hardware monitor receiving data and signals from the miss facility, decoder, execution and completion units. FIGS. 5, 6, and 7 show a high level logic flowchart which illustrates a method for accomplishing these functions.

FIG. 5 illustrates the method for determining the miss cluster size. As depicted this process begins at block 305. Each cycle the hardware monitor is sent signals and data from the miss facility indicating if a miss is in progress or a new miss has just started. If the processor is not processing a miss, control passes to block 307 where the Miss-Active signal is set to zero and the process terminates. However, if a miss is in progress control passes to block 310 where two signals are set. The Miss-Active signal is set one (indicating a miss cluster is in progress) and the TempEndOp signal is set to 0 indicating that the supremum instruction has not been determined.

Next a test is made to determine if a new miss cluster 320 has just begun. Variable Cluster-Size (Csize) is tested for zero. If the value is zero, this is the first miss of the new miss cluster. In block 330 the LastDecodeIID identifies the last instruction that was decoded. This identifier is saved in variable MissStart. Recall, the infimum instruction of a miss cluster is the instruction that just decoded prior to the first miss in the miss cluster. When all miss processing for this miss cluster is complete and the miss facility is idle, the infimum of the miss cluster will be set to the MissStart value.

Finally the miss cluster size (Csize) is determined. Block 340 determines if this is the start of a new miss. This signal is supplied to the hardware monitor on each cycle. If this is the first cycle of a new miss, Csize is incremented. The process then terminates.

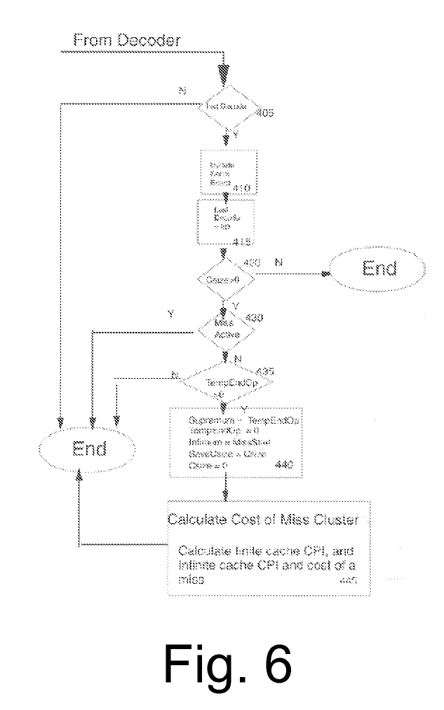

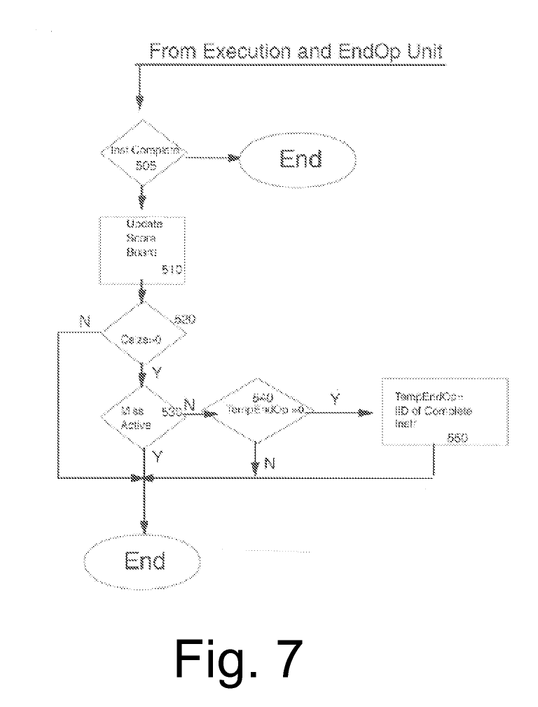

The hardware monitor also uses signals and data form the decoder and execution and EndOp units to fill in the trace scoreboard. This process is illustrated in FIG. 6 (from the decoder) and FIG. 7 (from the Execution and EndOp unit). Each cycle the hardware monitor receives decode information from the decoder. FIG. 6 illustrates this process. Block 405 determines if an instruction was decoded this cycle. If the decoder was idle this cycle this process end. However, if an instruction was decoded, the process proceeds to block 410 where the trace scoreboard is filled in with the information supplied by the decoder. The hardware monitor used the NextEntry pointer of the TSB to identify the row to contain the decode information for the instruction just decoded. Here the following fields of the TSB are filled in: the IID of instruction just decoded 205; instruction address 210; instruction image 215; operand address 220; the branch tag 235 is set to 1 if the instruction is a branch, 0 otherwise; the branch prediction 240 is filled in, 1 equals predicted taken, 0 equals predicted not-taken; the completion bit 250 is set to 0 (this bit will be set to 1 if the instruction completes); the decode time 255 is set; the miss-active bit 265 is set to 1 if a miss is in progress, 0 otherwise; and registers and contents needed for decode are saved in register values 275. After all decode information is specified in the TSB, the NextEntry pointer is incremented by one to point to the next new entry in the TSB.

Processing then proceeds to block 415 where the IID of the instruction just decoded is saved in the Last-Decode register. Blocks 420 through 435 determine if a miss cluster is in progress and is still waiting to establish a supremum instruction. In block 420, the cluster size variable is examined to determine if a miss cluster is in progress. If Csize is greater than 0 a miss cluster is in progress (or just completed) and processing continues to block 430. Block 430 determines if the miss facility is active. If the miss facility is idle, processing of the miss cluster has recently completed (note Csize is greater than 0) and control proceeds to block 435 to determine if a supremum for the miss cluster has been established. Recall the supremum of the miss cluster is the first instruction that EndOps after the miss facility becomes idle. If the supremum for the miss cluster just completed is set (TempEndOp is greater than zero), the cost of the miss cluster can be calculated. Block 435 determines if the supremum instruction for the miss cluster has been established.

In block 440 the supremum, infimum, and cluster size for the miss cluster are saved in Supremum, Infimum, and SaveCsize registers respectively. Recall the MissStart and LastDecode registers contain the IIDs of the instructions designated as the infimum and supremum of the miss cluster. These values will be used by the hardware monitor to calculate the cost of the miss. Variables TempEndOp and Csize are set to zero, in preparation for a new miss cluster and processing proceeds to block 445.

Before describing the logic in block 445 it is helpful to describe the actions of the hardware monitor for processing signals and data sent for the Execution and EndOp unit. Each cycle the hardware monitor receives signals and data from the execution and EndOp units. FIG. 7 illustrates this process. As depicted this process begins at block 505. If an instruction competed this cycle processing continues to block 510, otherwise this process ends.

In block 510 the TSB is updated with signals and data from the execution and EndOp units. The IID of the instruction that just completed is used to search the IID fields in the TSB 205 to find its matching entry. Recall this IID was saved in the TSB when the instruction was decoded. When found the following fields of the TSB of the matching entry are filled in: If the institution is a branch, the branch action field 245 of the TSB is set 1=taken, 0=not-taken; the completion bit of the TSB is set to 1 denoting the instruction is complete; the EndOp time 260 is set; the miss-active bit 270 is set to 1 if a miss is in progress, 0 otherwise; and registers and contents needed for execution are saved in register values 275.

Processing then proceeds to block 520 where is it determined if a miss cluster is still being processed. Note, the logic contained in blocks 520 through 550 is used to determine if processing the miss cluster is over and an supremum instruction for the miss cluster has been established. If the cluster size is greater than 0, (a miss cluster is being processed), processing proceeds to block 530 where it is determined if the miss facility is currently active. If the miss facility is idle (all miss activity has stopped) processing proceeds to block 540 where it is determined if a temporary EndOp instruction has been establish (a supremum for the miss cluster). If no supremum for the miss cluster has be determined (TempEndOp=0), TempEndOp is set to the IID of the instruction that just completed. This will be used for the supremum of the miss cluster.

Returning back to FIG. 6, Block 450 depicts the calculation of the cycles per miss for the current miss cluster using the instruction sequence and information saved in the TSB of the hardware monitor according to present invention. Those having ordinary skill in the art will appreciate that by providing the complete sequence of instructions that occurred during a miss (or miss cluster) along with the instructions images, instruction address, operand address and contents, branch prediction and action indicators (taken and not-taken), condition code settings, decode and EndOp times, and register contents, with the starting time of the miss cluster, the ending time of the miss cluster both infinite cache and finite cache CPI can be determined.

The finite cache CPI can be computed directly from values saved in the TSB. The finite cache running time of the miss cluster is the difference between the EndOp time of the supremum instruction and the decode time of the infimum instruction. The IID for these instructions are save in the Supremum and Infimum registers of the hardware monitor. The TSB is then searched to locate the row containing these instructions. The finite cache cycles for the miss cluster is then [Supremum (260)−Infimum (255)].

There are several ways to calculate the infinite cache times for the instruction sequence saved between the Infimum and Supremum registers. In the preferred embodiment the hardware monitor is a duplicate of the processor it is monitoring with a special mode bit. If the mode bit is one, all cache references made by the monitor are sent to the cache (the monitor acts as a duplicate of the processor it is monitoring). However, if the mode bit is zero the operations of the monitor are changed. When the mode bit is zero, the monitor will behaviorally mimic the action of the processor it is monitoring, however all cache references are sent to the TSB instead of the cache. Recall the TSB saved all of the instructions, and images, data addresses and contents of all instructions that were executed by the processor during a mss cluster. With this feature, the monitor can avoid all cache misses and the infinite cache running time (cycles) for the instructions that occurred during the miss cluster can be determined. With a mode setting at zero, the hardware monitor will re-execute the sequence of instruction between the infimum and supremum instruction without generating any cache misses. This execution time will then represent the infinite cache cycles for the instructions that surround the miss cluster. The difference between the finite cache cycle and infinite cycle is the cost of the miss cluster (in cycle).

The amount of time associated with the cost of a miss is then saved in an array and displayed after a fixed number of miss clusters have been measured. For example, let DELTA equal the cost of the missed cluster, that is, DELTA equals the difference between the finite cache cycles and infinite cache cycles of a miss cluster, and let COST represent a two dimensional array where the first dimension represents the CLUSTER_SIZE and the second dimension represents the cost of the miss cluster, then array entry COST(CLUSTER_SIZE, DELTA) contains the number of miss clusters that had DELTA cycles of delay. Displaying the values of this array as a distribution will produce a miss spectrogram as shown in FIG. 2.

Described above is a mechanism used to measure and display the cost of a cache miss. This mechanism is a preferred embodiment but does not indicate that alternative embodiments are less effective. Alternative mechanism are given below.

In an alternate embodiment the hardware monitor uses the processor it is monitoring to re-execute the sequence of instructions between the infimum and supremum instructions. Since this sequence of instructions is the most-recently-executed set of instructions (and relatively short in length) and saved in the TSB all instructions and data should still be in the processor's cache. Again the processor has a mode bit that specifies normal operations or use the instructions and information saved in the TSB to guide the execution flow. By re-executing these instructions on the same processor, all cache misses should be avoided. Thus an infinite cache running time can be produced. Once this time is produced (infinite cache time) the finite cache running time is obtained in a similar manner as described above and the cost of the miss cluster can be calculate as before. After these instructions have been re-executed, the processor can switch back to normal operations.

In another alternate embodiment the hardware monitor can spawn the set of instructions between the infimum and supremum instructions as a second thread on the original processor to produce the infinite cache running time. Again the processor has a mode bit to specify when cache requests are sent to the cache (normal processing) or sent to the TSB. Whenever the second thread is running on the original processor, the mode bit is set to direct all cache references to be sent to the TSB. Once the infinite cache running time is produced the monitor can calculate the cost of a miss as described above.

In yet another alternate embodiment the hardware monitor can have a set of known (average) infinite cache execution times for each instructions saved in the TSB. The infinite cache running time for the sequence of instructions between the infimum and supremum instructions can then be obtained by summing the average execution times for each instruction. The cost of the miss cluster can then be calculated using the methods described above.

In yet another alternate embodiment the hardware monitor can invoke simulation software to accurately calculate the infinite cache running time for the sequence of instructions between the infimum and supremum instructions. Software simulators are commonly used in the art to determine the performance of a processor (both present and future). In this alternate embodiment, the simulator must be able to accurately model the processor on a cycle-by-cycle basis and produce the infinite cache running time of the instructions that occurred during the miss cluster. Once the infinite cache running time is produced the cost of the miss cluster can be calculated as described above.

In the drawings and specifications there has been set forth a preferred embodiment of the invention and, although specific terms are used, the description thus given uses terminology in a generic and descriptive sense only and not for purposes of limitation.

What is claimed is:

1. Method comprising:
monitoring a computer system which has a central processing unit, cache memory, working memory and storage memory for occurrences of pipeline events;
computing the difference (T₁−T₂) between operational time of the computer system with the occurrence of monitored pipeline events (T₁) and operational time of the computer system free of the occurrence of monitored pipeline events (T₂); and
displaying the computed difference (T₁−T₂).

2. Method according to claim 1 wherein the monitored pipeline events are selected from the group consisting of cache misses, branch prediction errors and execution interlocks.

3. Method according to claim 1 wherein the monitoring comprises identifying clusters of cache misses.

4. Method according to claim 3 wherein the computing comprises grouping misses according to cluster size and calculating the delay associated with a miss cluster.

5. Method according to claim 4 wherein the calculation of delay comprises determining the number of stalled processor cycles.

6. Method according to claim 3 wherein the displaying comprises graphically representing a plot of latency delays along one ordinate and percentage of cache misses along the other ordinate.

7. Method according to claim 6 wherein latency delays are displayed along a horizontal ordinate and percentage of cache misses along a vertical ordinate.

8. Method according to claim 3 further comprising recording in a trace scoreboard the instructions occurring during a sequence of cache misses and wherein the computing of times T₁ and T₂ is bounded by the instructions occurring during a corresponding sequence of cache misses.

9. Method according to claim 3 wherein the computed difference represents the cost in CPU cycles of monitored cache misses.

10. Apparatus comprising:
a computer system having a central processing unit, cache memory, working memory and storage memory; and
a hardware monitor operatively associated with said computer system and monitoring said computer system for occurrences of pipeline events during execution of instruction sequences, said hardware monitor computing the difference (T₁−T₂) between operational time of the computer system with the occurrence of monitored pipeline events (T₁) and operational time of the computer system free of the occurrence of monitored pipeline events (T₂); and
a display coupled to said hardware monitor and responding to a computed difference in operational times T₁ and T₂ by displaying the cost in operational cycles of monitored pipeline events.

11. Apparatus according to claim 10 wherein said hardware monitor monitors for occurrences of pipeline events selected from among the group consisting of cache misses, branch prediction errors and execution interlocks.

12. Apparatus according to claim 10 wherein said hardware monitor identifies clusters of cache misses.

13. Apparatus according to claim 12 wherein said hardware monitor groups misses according to cluster size and calculates the delay associated with a miss cluster.

14. Apparatus according to claim 13 wherein said hardware monitor calculates delay by determining the number of stalled processor cycles associated with a miss cluster.

15. Apparatus according to claim 11 wherein said display graphically represents a plot of latency delays along one ordinate and percentage of cache misses along the other ordinate.

16. Apparatus according to claim 15 wherein said display displays latency delays along a horizontal ordinate and the percentage of cache misses along a vertical ordinate.

17. Apparatus according to claim 11 wherein said hardware monitor records in a trace scoreboard the instructions occurring during a sequence of cache misses and wherein the computing of times T₁ and T₂ is bounded by the instructions occurring during a corresponding sequence of cache misses.

18. Apparatus according to claim 11 wherein the computed difference represents the cost in CPU cycles of monitored cache misses.
